(19) United States
(12) Patent Application Publication
(10) Pub. No.: US 2021/0223038 A1
(43) Pub. Date: Jul. 22, 2021

(54) DISTANCE MEASUREMENTS INCLUDING SUPPLEMENTAL ACCURACY DATA

(71) Applicant: Magik Eye Inc., New York, NY (US)

(72) Inventor: Akiteru Kimura, Hachioji (JP)

(21) Appl. No.: 17/149,829

(22) Filed: Jan. 15, 2021

Related U.S. Application Data
(60) Provisional application No. 62/962,968, filed on Jan. 18, 2020.

(51) Int. Cl. G01C 3/26

(52) U.S. Cl. CPC G01C 3/26

(57) ABSTRACT

An example method includes causing a light projecting system of the distance sensor to project a three-dimensional pattern onto an object, wherein the three-dimensional pattern comprises a plurality of points of light, causing a light receiving system of the distance sensor to capture an image of the three-dimensional pattern projected onto the object, calculating a first set of three-dimensional coordinates for a first point of the plurality of points of light, wherein the calculating is based on an appearance of the first point in the image and knowledge of a trajectory of the first point, retrieving a first distance measurement characteristic for the first point that is measured during a calibration of the distance sensor, appending the first distance measurement characteristic to the first set of three-dimensional coordinates, and outputting a set of data including the first set of three-dimensional coordinates appended with the distance measurement characteristic.

### CROSS REFERENCE TO RELATED APPLICATIONS

This application claims the priority of U.S. Provisional Patent Application Ser. No. 62/962,968, filed Jan. 18, 2020, which is herein incorporated by reference in its entirety.

### FIELD OF THE INVENTION

The invention related generally to distance measurement, and relates more particularly to supplementing distance measurements calculated by triangulation using multipoint projection with data indicative of measurement accuracy.

### BACKGROUND

Many techniques, including autonomous navigation, robotics, and other applications, rely on the measurement of a three-dimensional map of a surrounding space to help with collision avoidance, route confirmation, and other tasks. For instance, the three-dimensional map may indicate the distance to various objects in the surrounding space.

Different applications and situations may require different degrees of accuracy when it comes to distance measurement. For instance, when using triangulation techniques for collision avoidance in an automatic navigation application, the required accuracy of the distance measurement is high for short distances where precise attention is required (e.g., where collisions are more likely), but lower for longer distances where less precise attention may be warranted (e.g., where collisions are less likely). On the other hand, applications whose purpose is to recognize the shapes of objects may be able to achieve an acceptable level of performance using less accurate distance measurements.

### SUMMARY

In one example, a method performed by a processing system of a distance sensor including at least one processor includes causing a light projecting system of the distance sensor to project a three-dimensional pattern onto an object, wherein the three-dimensional pattern comprises a plurality of points of light, causing a light receiving system of the distance sensor to capture an image of the three-dimensional pattern projected onto the object, calculating a first set of three-dimensional coordinates for a first point of the plurality of points of light, wherein the calculating is based on an appearance of the first point in the image and knowledge of a trajectory of the first point, retrieving a first distance measurement characteristic for the first point from a memory of the distance sensor, wherein the first distance measurement characteristic is measured during a calibration of the distance sensor, appending the first distance measurement characteristic to the first set of three-dimensional coordinates, and outputting a set of data including the first set of three-dimensional coordinates appended with the distance measurement characteristic.

In another example, a non-transitory machine-readable storage medium is encoded with instructions executable by a processing system of a distance sensor including at least one processor. When executed, the instructions cause the processing system to perform operations including causing a light projecting system of the distance sensor to project a three-dimensional pattern onto an object, wherein the three-dimensional pattern comprises a plurality of points of light, causing a light receiving system of the distance sensor to capture an image of the three-dimensional pattern projected onto the object, calculating a first set of three-dimensional coordinates for a first point of the plurality of points of light, wherein the calculating is based on an appearance of the first point in the image and knowledge of a trajectory of the first point, retrieving a first distance measurement characteristic for the first point from a memory of the distance sensor, wherein the first distance measurement characteristic is measured during a calibration of the distance sensor, appending the first distance measurement characteristic to the first set of three-dimensional coordinates, and outputting a set of data including the first set of three-dimensional coordinates appended with the distance measurement characteristic.

In another example, a distance sensor includes a processing system including at least one processor and a non-transitory machine-readable storage medium encoded with instructions executable by the processing system. When executed, the instructions cause the processing system to perform operations including causing a light projecting system of the distance sensor to project a three-dimensional pattern onto an object, wherein the three-dimensional pattern comprises a plurality of points of light, causing a light receiving system of the distance sensor to capture an image of the three-dimensional pattern projected onto the object, calculating a first set of three-dimensional coordinates for a first point of the plurality of points of light, wherein the calculating is based on an appearance of the first point in the image and knowledge of a trajectory of the first point, retrieving a first distance measurement characteristic for the first point from a memory of the distance sensor, wherein the first distance measurement characteristic is measured during a calibration of the distance sensor, appending the first distance measurement characteristic to the first set of three-dimensional coordinates, and outputting a set of data including the first set of three-dimensional coordinates appended with the distance measurement characteristic.

### BRIEF DESCRIPTION OF THE DRAWINGS

FIG. 1A is a schematic diagram illustrating the relationship between object position and distance measurement accuracy when measuring distance by triangulation using multipoint projection;

FIG. 1B illustrates the effect of point position on the accuracy of a distance measurement;

FIG. 2 is a flow chart illustrating an example method for measuring the distance from a distance sensor to an object;

FIG. 3 illustrates an example trajectory fora point of a projected pattern;

FIG. 4 illustrates an example projected pattern that shows the variations that may exist among the points of the projected pattern;

FIG. 5 illustrates an example projected pattern in which the appearance of the points varies when viewed from different distances; and

FIG. 6 depicts a high-level block diagram of an example electronic device 600 for measuring the distance from a distance sensor to an object.

### DETAILED DESCRIPTION

The present disclosure broadly describes an apparatus, method, and non-transitory computer-readable medium for supplementing distance measurements calculated by triangulation using multipoint projection with data indicative of measurement accuracy. As discussed above, many techniques, including autonomous navigation, robotics, and other applications, rely on the measurement of a three-dimensional map of a surrounding space to help with collision avoidance, route confirmation, and other tasks. There are various methods for measuring a three-dimensional map. One particular method that may be used is triangulation by simultaneous multipoint projection, which measures the distance of a plurality of points of light at the same time. The plurality of points of light is projected as a pattern onto the surface or object whose distance is being measured, and the appearance of the pattern in an image of the surface or object may be used to compute the distance to the surface or object. U.S. patent application Ser. Nos. 14/920,246, 15/149,323, and 15/149,429, for example, describe methods for distance measurement using simultaneous multipoint projection.

When using triangulation techniques, the resolution of the distance measurement tends to decrease as the distance to the object increases. This is due at least partially to the fact that triangulation techniques such as those described above must be able to reliably detect and identify individual points of the plurality of points of light in order to accurately measure distance. The ability to detect and identify points in a projected pattern may be affected by the conditions under which the measurement is being made and the characteristics of the projected points of light, which may vary with distance. For instance, noise from ambient light and/or object reflectance can interfere with the detection and recognition of the points of light. Characteristics of the points of light, such as brightness, shape, size, and the like can also affect the ability of the distance sensor to reliably detect and recognize the points of light.

The accuracy of a distance measurement made using triangulation techniques may also be affected by the process used to calibrate the distance sensor. Calibration comprises a process by which a position in a three-dimensional coordinate space of each point of light may be associated with a location on an imaging sensor of the distance sensor's light receiving system (e.g., camera). A given point of light may have a plurality of potential positions along a trajectory (i.e., a moving range of positions along which the point of light may fall, depending on object distance) which may be stored for the given point. The accuracy of the distance sensor is increased when a greater number of potential positions of each point can be associated with locations on the imaging sensor.

However, it may take a great deal of time to make all of the measurements that are needed to achieve this greater accuracy. Thus, to save time, fewer potential positions of each point may be measured and associated with corresponding locations on the imaging sensor. Imaging sensor locations corresponding to point positions which are not explicitly measured may be assumed (e.g., through extrapolation). This abbreviated calibration process may result in decreased accuracy in the detection and distance measurement of points, however. For instance, if a point falls outside of a stored trajectory for the point which is determined through an abbreviated calibration process, the processing system may fail to detect the point or may misidentify the point (e.g., associate the point with an incorrect trajectory and imaging sensor location).

As discussed above, different applications and situations may require different degrees of accuracy when it comes to distance measurement. Applications such as collision avoidance may require a high degree of accuracy when measuring shorter distances, but the same degree of accuracy may be less vital for measuring longer distances. On the other hand, applications whose purpose is to recognize the shapes of objects may be able to achieve an acceptable level of performance using less accurate distance measurements. Thus, different types of applications may require different degrees of precision when it comes to distance measurement.

Examples of the present disclosure measure distance independently for each point of light in a projected pattern. This allows distance measurement characteristics, which may vary from point to point, to be associated with the individual distance measurement for each point. In one example, at least two points in the same projected pattern may have different distance measurement characteristics.

Thus, in one example, the present disclosure outputs, for at least one point of a plurality of points that forms a projected pattern, a distance measurement to the point (which may be calculated independently of the distances to any other points of the pattern as discussed above) and distance measurement characteristics for the point (which may be unique to the point). An application utilizing the distance measurement to perform a task (such as collision avoidance, autonomous navigation, or the like) may be able to infer the accuracy of the distance measurement based at least in part on the distance measurement characteristics for the point, and may be able to determine whether the accuracy of the distance measurement is sufficient for the task being performed.

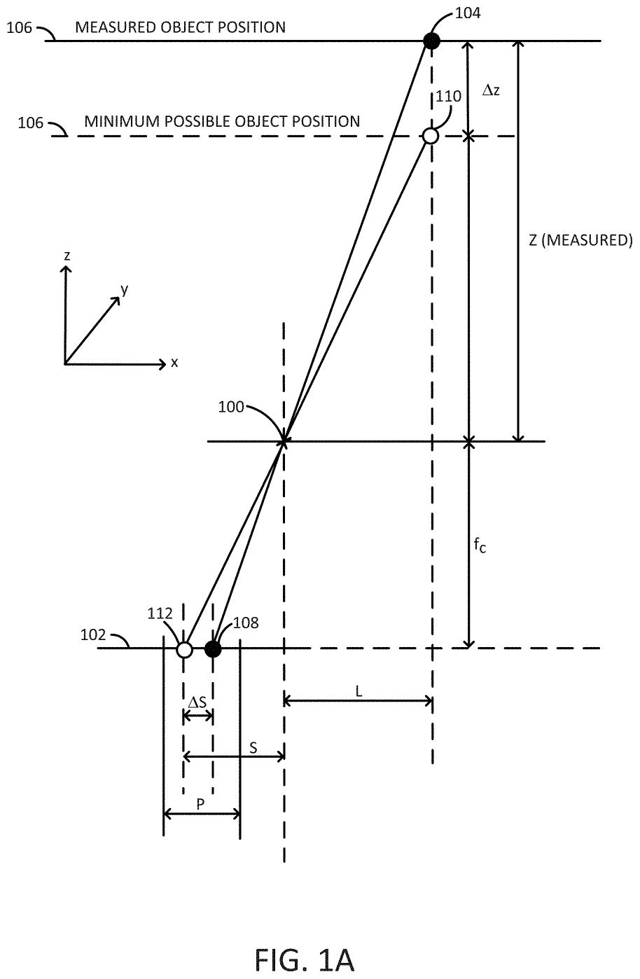

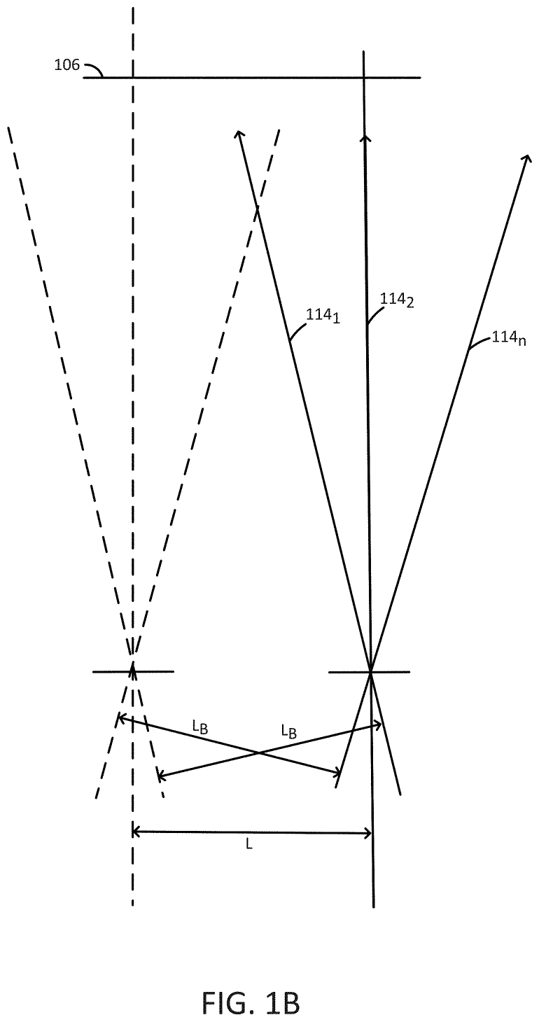

FIG. 1A is a schematic diagram illustrating the relationship between object position and distance measurement accuracy when measuring distance by triangulation using multipoint projection. As discussed above, according to the principles of triangulation, the accuracy of a distance measurement measured by triangulation typically decreases as the distance increases.

As shown in FIG. 1A, the light receiving system of a distance sensor (i.e., the subsystem of the distance sensor that is responsible for capturing the images of the object and the projected pattern) includes a lens having a front nodal point 100 and an imaging sensor 102 comprising a plurality of pixels. A point 104 (e.g., a point that is projected onto an object 106 by a light projecting system of the distance sensor) represents the position (z axis distance, or depth z₁) of the object 106 as measured by the distance sensor. The point 104 may have a corresponding position 108 on the imaging sensor 102. A point 110 may represent the minimum possible position of the object 106 (e.g., based on a stored trajectory of the point 104 that is determined through calibration). The point 110 may have a corresponding position 112 on the imaging sensor 102. A distance Δz in the z direction between the point 104 and the point 110 represents a distance resolution of the distance sensor.

The length L of the distance sensor base line measures a linear distance (e.g., along the x axis) between the front nodal point 100 and the x coordinate of the positions of the points 104 and 110. The focal length f_{c} of the distance sensor measures the distance (e.g., along the y axis) between the front nodal point 100 and the imaging sensor 102. The x and y coordinates of the point 104 and the point 110 may be the same or may be different.

The x component of the position of the point 112 on the imaging sensor 102 may be measured as the linear distance s (e.g., along the x axis). A distance Δs in the x direction between the point 112 and the point 108 represents a minimum resolution of image movement. (e.g., by a software parameter). In one example, the distance Δs may be calculated as:

$$Δ s = \frac{{f}_{c} \times L \times Δ z}{( z + Δ z ) \times z} \qquad ( EQN . 1 )$$

where

$$\begin{matrix}s = \frac{{f}_{c} \times L}{Δ z} \\ and & ( EQN . 2 ) \\ s + Δ s = \frac{{f}_{c} \times L}{( z + Δ z )} & ( EQN . 3 )\end{matrix}$$

In another example, the distance Δs may be calculated as a function of a software parameter K according to:

Δs=P/K (EQN. 4)

where P is equal to the pixel size of the imaging sensor 102. The software parameter K is determined by the characteristics of the light receiving system, the resolution of the imaging sensor 102, and the specifications of the software related to the distance resolution. However, since the specifications of the light receiving system may vary, it may be desirable to check and measure the value of K before making any distance measurements. In one example, the value of software parameter K is unique to the distance sensor.

Using EQNs. 1 and 4, a range for the distance z can be calculated as part of the distance measurement accuracy estimation. The range may be defined as zₘᵢₙ−zₘₐₓ, where zₘᵢₙ<z<zₘₐₓ. For instance, the point 110 may be positioned at zₘᵢₙ.

Thus, as illustrated in FIG. 1A, distance measurement accuracy depends on the following factors: object distance, point position, optics specifications (e.g., optical layout, lens specification, etc.), imaging sensor specifications (e.g., number of pixels), and software algorithms and parameters.

FIG. 1B illustrates the effect of point position on the accuracy of a distance measurement. As shown in FIG. 1B, in the case of multipoint projection, the angle formed between the beam of light 114₁-114ₙ (hereinafter individually referred to as a “beam 114” or collectively referred to as “beams 114”) that creates a point and the base line L of the distance sensor will differ depending upon the direction of projection of the beam 114. L_{B} is measured as the distance between a pair of parallel beams and represents the practical base line length at an oblique projection.

The position of the point on the object will also affect the accuracy of the distance measurement. Thus, the accuracy of the distance measurement may be determined theoretically by the specifications and arrangement of the distance sensor's optical system (e.g. light projecting and light receiving systems) and by the specifications of the imaging sensor. As such, the accuracy of the distance measurement calculation can be calculated based on primarily theoretical values that do not change between devices (but which do need to be supported by actual measurements).

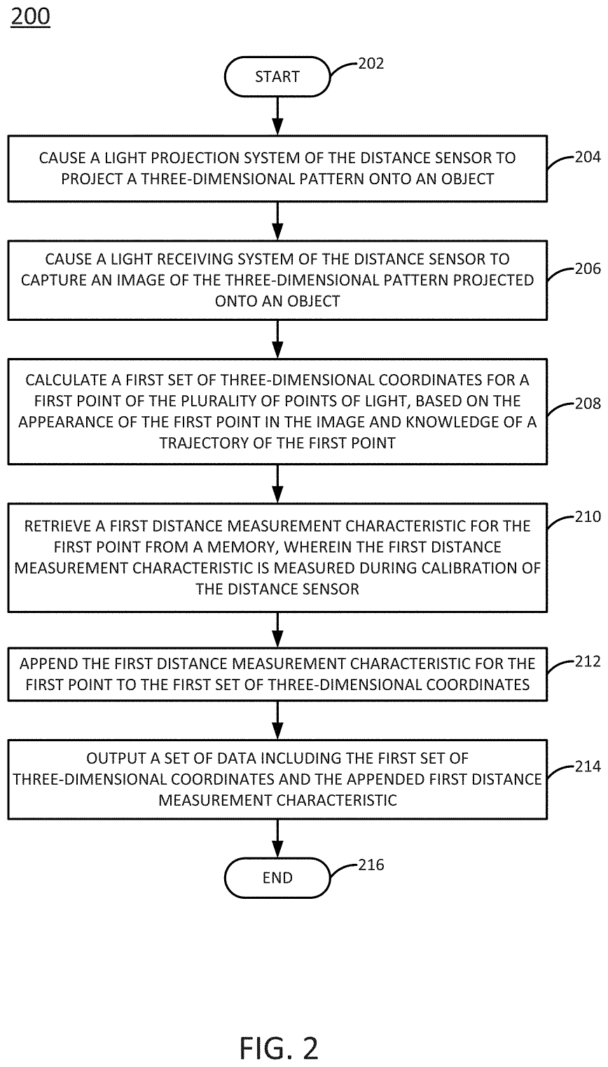

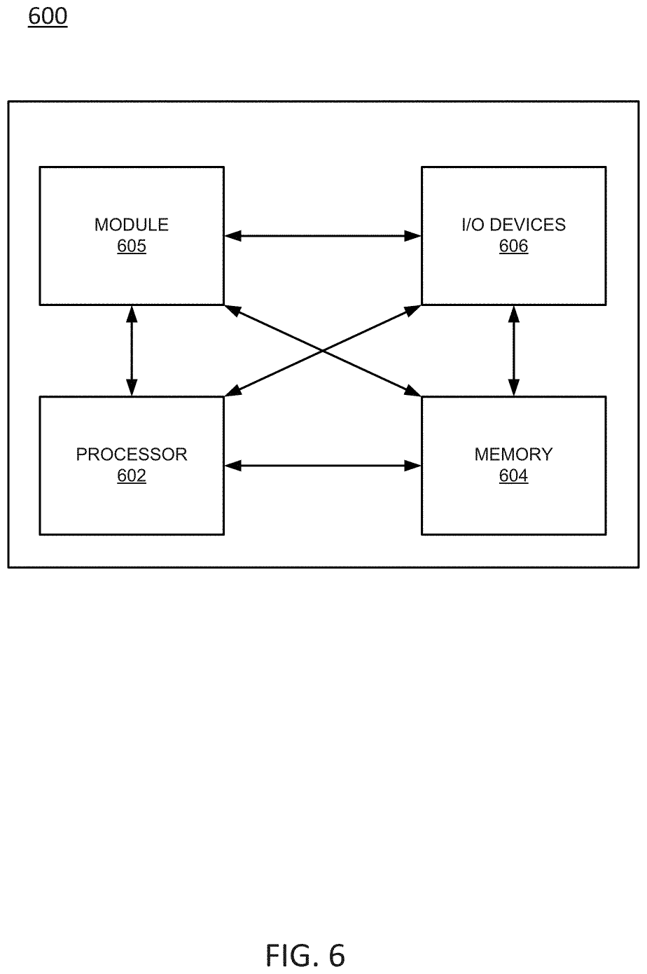

FIG. 2 is a flow chart illustrating an example method 200 for measuring the distance from a distance sensor to an object. The method 200 may be performed, for example, by a processing system including at least one processor, such as the processing system of a distance sensor. Alternatively, the method 200 may be performed by a processing system of a computing device, such as the computing device 600 illustrated in FIG. 6 and described in further detail below. For the sake of example, the method 200 is described as being performed by a processing system.

The method 200 may begin in step 202. In step 204, the processing system of a distance sensor may cause a light projecting system of the distance sensor to project a three-dimensional pattern onto an object. The light projecting system of the distance sensor may comprise, for example, a laser light source that emits one or more beams of light in a wavelength that is substantially invisible to the human eye (e.g., infrared light). The light projecting system of the distance sensor may additionally comprise optics (e.g., diffractive optical elements, lenses, etc.) that split the beam(s) of light emitted by the laser light source into a plurality of additional beams of light. Thus, the light projecting system may project a plurality of beams of light. When each beam of the plurality of beams of light is incident upon an object, the beam creates a point of light (e.g., a dot or other shape) on the object. A plurality of points of light creates by the plurality of beams collectively forms a pattern of light on the object. The pattern of light may comprise a predefined arrangement of the plurality of points of light. For instance, the plurality of points of light may be arranged in a grid comprising a plurality of rows and a plurality of columns.

In step 206, the processing system may cause a light receiving system of the distance sensor to capture an image of the three-dimensional pattern projected onto the object. The light receiving system of the distance sensor may comprise, for example, an imaging sensor and one or more lenses that collectively form a camera. The imaging sensor may include an array of photodetectors and optional filters that is capable of detecting the points of light of the three-dimensional pattern. For instance, the photodetectors may include infrared photodetectors, and the filters may include infrared bandpass filters.

In step 208, the processing system may calculate a first set of three-dimensional coordinates for a first point of the plurality of points of light, based on the appearance of the first point in the image and knowledge of a trajectory of the first point. The first set of three-dimensional coordinates may comprise (x, y, z) coordinates, where the z coordinate may measure a first distance (or depth) of the point from the distance sensor. As discussed above, the trajectory of the first point may comprise a moving range within which the first point's position may vary with the distance to the object. The trajectory of the first point may be learned, prior to performance of the method 200, through a calibration of the distance sensor.

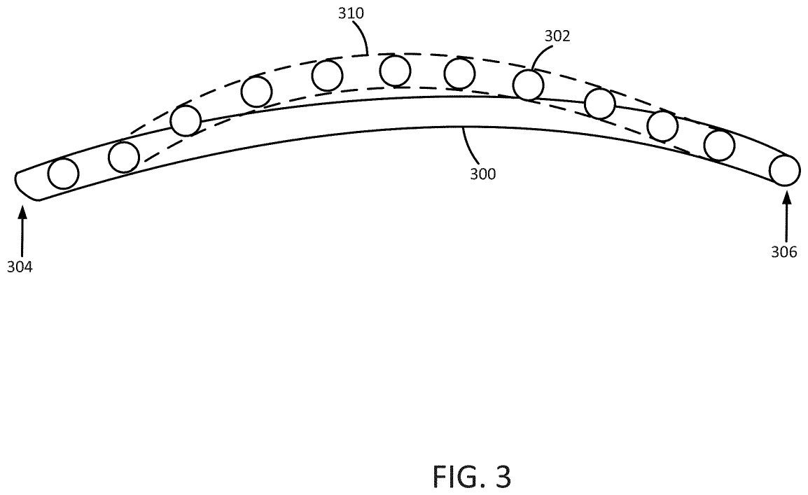

FIG. 3, for instance, illustrates an example trajectory 300 for a point 302 of a projected pattern. As illustrated, the trajectory 300 may include a first end 304 and a second end 306. The shaded space between the first end 304 and the second end 306 may represent the potential range of positions over which the point 302 may be detected when projected onto an object. That is, when a point of a projected pattern is detected at a position that falls within the trajectory 300, then the point may be identified as the point 302, which is associated with (i.e., created by) a specific beam emitted by the light projecting system that produces the projected pattern. The ability to identify a detected point as a specific point associated with a specific beam is what allows the triangulation process to accurately measure distance.

The precise position within the trajectory 300 of the point 302 may vary with the distance to the object. The relationship between the position of the point 302 within the trajectory 300 and the distance to the object may be determined by the calibration process described above. The trajectory 300 and the relationship may both be stored in memory (e.g., a local memory of the distance sensor and/or a remote database that is accessible by a processor of the distance sensor).

The calculated first distance to the first point may be calculated using triangulation techniques, based on the identification of the first point. In one example, the calculated first distance to the first point is calculated independently of the distances to any other points of the plurality of points of light.

In step 210, the processing system may retrieve a first distance measurement characteristic for the first point from a memory of the distance sensor, where the first distance measurement characteristic is measured during a calibration of the distance sensor. The first distance measurement characteristic may be a characteristic of the first point that affects the processing system's ability to accurately detect and identify the first point.

In one example, the first distance measurement characteristic may comprise at least one of: a brightness of the point, a physical profile (e.g., size, shape, and/or variation by distance) of the point, capture optics factors associated with the point, and calibration specifications associated with the point. (e.g., whether the calibration process was abbreviated as discussed above). As discussed above, the first distance measurement characteristic may be measured during a calibration (e.g., performed during manufacture) of the distance sensor and stored in memory for later retrieval. The memory may comprise a local memory of the distance sensor or may comprise a remote memory (e.g., database) that is accessible by the distance sensor. The first distance measurement characteristic may also be re-measured (e.g., after manufacture, in the field) and updated in the memory. For instance, certain distance measurement characteristics may change over time or in response to different conditions of use.

The brightness of a point may impact the ability of the processing system to accurately detect the point for distance measurement. For instance, the brighter a point is, the easier it is to visually distinguish the point from noise (e.g., introduced by ambient light and/or object reflectance). A point having reduced light intensity (i.e., less brightness) may be harder to visually distinguish from surrounding noise in the image, making the point's presence harder for the processing system to detect.

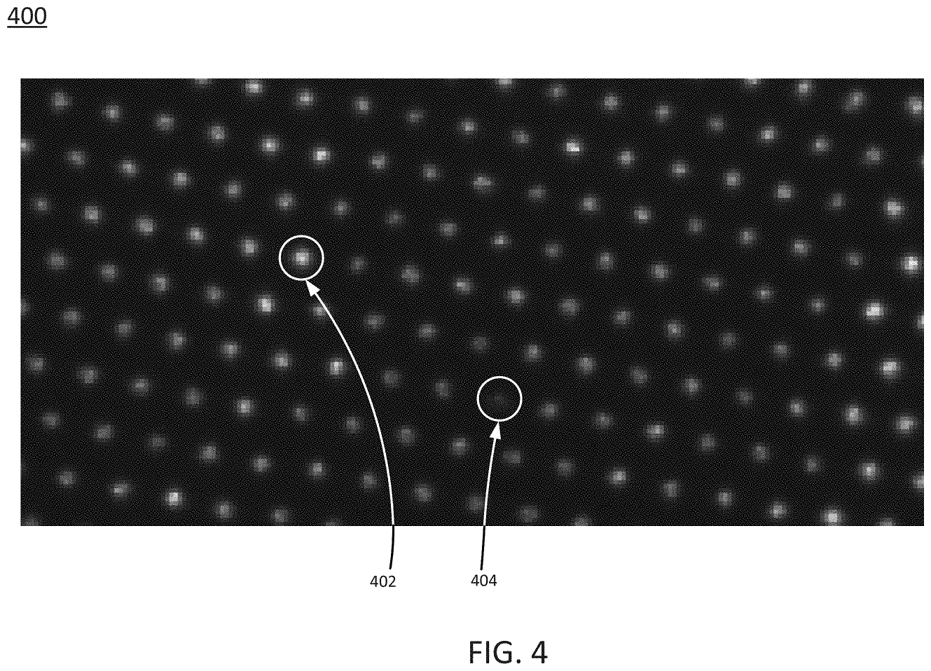

FIG. 4, for instance, illustrates an example projected pattern 400 that shows the variations that may exist among the points of the projected pattern 400. As an example, the point 402 is brighter than the point 404. The increased brightness of the point 402 makes the point 402 more visible than the point 404 and easier to detect as a point of the pattern (as opposed to noise). Thus, in some examples, a point that is less bright (e.g., less bright than an average point brightness) may fail to be detected by the distance sensor (e.g., may appear as “missing” from the projected pattern). Conversely, in other examples, a point that is more bright (e.g., brighter than an average point brightness) may be detected and treated by the distance sensor as an anomaly.

The physical profile of a point may also impact the ability of the processing system to accurately detect the point for distance measurement. For instance, different point shapes (e.g., dots, ellipses, stars, etc.) may exhibit different degrees in variation when viewed from different distances. Moreover, the perceived shape of a point may vary depending upon the distance from which the point is viewed.

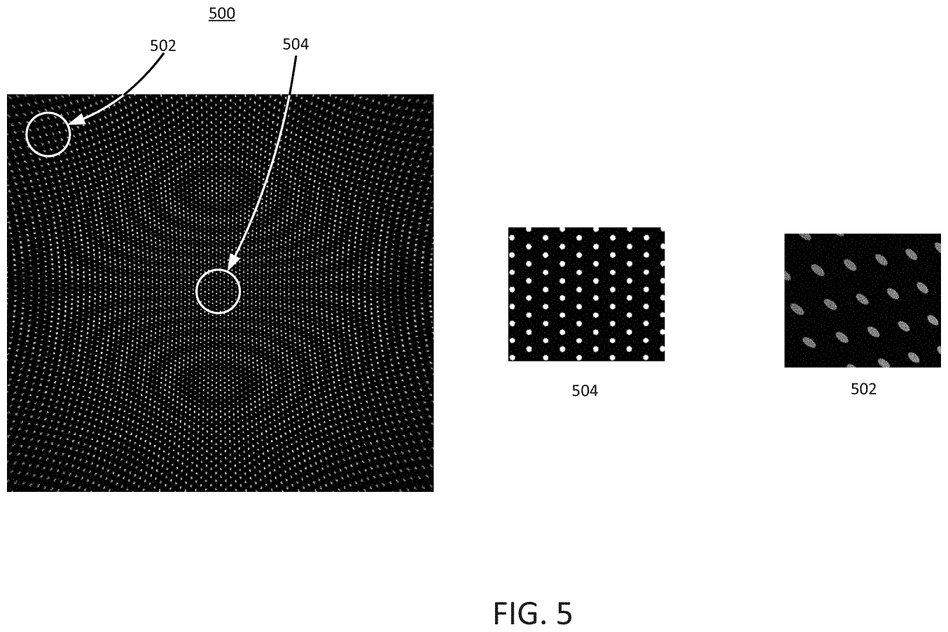

FIG. 5, for instance, illustrates an example projected pattern 500 in which the appearance of the points varies when viewed from different distances. As an example, a section 502 of the pattern 500 may be viewed from a closer distance than a section 504 of the pattern 500. The individual points of the pattern 500 within the section 502 may appear further apart than the individual points of the pattern 500 within the section 504. Moreover, the shapes of the individual points within the section 502 may appear more clearly defined than the shapes of the individual points within the section 504.

In addition, process by which the distance sensor was calibrated (which may be abbreviated to reduce time and/or costs as discussed above) may also affect the processing system's ability to correctly detect and identify the first point. For instance, referring again to FIG. 3, if the trajectory 300 of FIG. 3 represents the stored trajectory for the point 302, then the trajectory 310 may represent the actual or observed trajectory or position of the point 302 in practice. As shown, the actual position of the point 302 may fall outside of the stored trajectory 300 for the point 302. The deviation of the observed position from the stored trajectory may vary depending upon the degree to which the calibration process was abbreviated (e.g., how many trajectory measurements were made for the point 302). The degree of deviation may also affect the ability of the processing system to detect the point 302 in a projected pattern. For instance, the greater the deviation of the position from the stored trajectory, the less likely it is that the point will be identifiable to the processing system as the point associated with the stored trajectory.

In another example, the first distance measurement characteristic may comprise a repair history of the distance sensor. For instance, certain types of modifications or updates made to the distance sensor to address maintenance or malfunctions may result in changes to the first distance measurement characteristic. Thus, the repair history may be stored in a memory that is accessible by the distance sensor.

In another example, the first distance measurement characteristic may comprise a temperature. The temperature may be an ambient temperature (e.g., a temperature of the environment in which the method 200 is being performed) or a temperature of a specific component of the distance sensor (e.g., a temperature of a light source). Changes in both ambient temperature and component temperature may affect the appearance of the projected pattern. Thus, during calibration of the distance sensor, the ambient temperature and/or the temperature of one or more components of the distance sensor may be measured and stored in memory. Later, during performance of the method 200, the current ambient temperature and/or component temperature may be measured or obtained by the distance sensor. The current ambient temperature and/or component temperature may be used to compute a correction to the first set of there-dimensional coordinates.

In one example, the distance sensor may include a temperature sensor (e.g., thermometer, thermocouple, thermal camera, etc.) that may be capable of directly measuring a temperature. Alternatively, if the distance sensor includes an interface or device for providing network connectivity, then the temperature may be provided by a remote information source (e.g., a remote sensor or database).

Referring back to FIG. 2, in step 212, the processing system may append the first distance measurement characteristic for the first point to the first set of three-dimensional coordinates. The first distance measurement characteristic for the first point may be used by an application to infer a confidence in or accuracy of the first set of three-dimensional coordinates, and in particular of a first distance of the first point from the distance sensor (as represented by the z coordinate of the first set of three-dimensional coordinates). The application may use the first distance measurement characteristic to adjust the manner in which the first set of three-dimensional coordinates is used by the application, based on the needs of the application.

In one example, the first distance measurement characteristic may include at least one of a set of coordinates including a minimum possible distance for the first point (e.g., (xₘᵢₙ, yₘᵢₙ, zₘᵢₙ)) or a set of coordinates including a maximum possible distance for the first point (e.g., (xₘₐₓ, yₘₐₓ, zₘₐₓ)). The minimum and maximum possible distances may be determined based on the trajectory for the first point, as noted above (e.g., based on the locations of the ends of the trajectory). The minimum possible distance and the maximum possible distance may define between them a range, where the actual first distance to the first point may fall somewhere between the minimum possible distance and the maximum possible distance. In this case, “minimum possible distance” and “maximum possible distance” refer specifically to the z (depth) value of the sets of coordinates. That is, the “minimum possible distance” represents a set of possible (x, y, z) coordinates for the first point for which the z value is smallest, while the “maximum possible distance” represents a set of possible (x, y, z) coordinates for the first point for which the z value is greatest. The x and y values of the coordinates may also change with the change in the z value.

In another example, the first distance measurement characteristic may include a unique identifier of the first point, i.e., an identifier that uniquely distinguishes the first point from the other points in the plurality of points (or uniquely identifies the beam that created the first point).

In another example, the first distance measurement characteristic may include a code or indicator that describes a confidence in the detection and recognition of the first point, based on the conditions under which the first point was detected (such as the reflectance of the object onto which the plurality of points was projected and/or the distance of the object). For instance, Table 1, below, is an example table illustrating the effects of object distance and object reflectance (or external light intensity) on the recognition rate of a point of a projected pattern (i.e., the number of times out of 100 tries during which a processing system was able to correctly detect and identify the point as being associated with a specific beam of light).

TABLE 1

| Object | Object | Recognition Rate | | |
|---|---|---|---|---|
| Reflectance | Distance | 100-80% | 80-30% | <30% |
| Bright | D1 (middle) | A | B | C |
| | D2 (far) | A | B | C |
| Dark | D1 (middle) | A | B | C |
| | D2 (far) | A | B | C |

As illustrated in Table 1, if the first point was detected on an object having bright reflectance at a middle distance, an indicator of A may be appended to the first set of three-dimensional coordinates to indicate that the recognition rate for points detected under similar conditions is 80-100% (e.g., the distances calculated for points detected under similar conditions are accurate 80-100% of the time).

In another example, the first distance measurement characteristic may comprise an indication as to a degree to which the first set of three-dimensional coordinates deviates from a stored trajectory for the first point. As discussed above, depending upon the calibration process performed for the distance sensor, the first point may be observed to occur at positions that fall outside of a stored trajectory defining an expected moving range of the first point.

In step 214, the processing system may output a set of data including the first set of three-dimensional coordinates and the appended first distance measurement characteristic. The method 200 may then end in step 216.

The method 200, and specifically steps 208-214, may be repeated for any number of other points of the plurality of points, including at least a second point. Thus, a second set of three-dimensional coordinates may be calculated for the second point, and a second distance measurement characteristic for the second point may also be determined and appended to the second set of three-dimensional coordinates. The second set of three-dimensional coordinates may be calculated independently from the first set of three-dimensional coordinates. Moreover, the second distance measurement characteristic may be different from the first distance measurement characteristic. For instance, the brightness, shape, or size of the first point may differ from the brightness, shape, or size of the first point. Similarly, other conditions such as ambient lighting and/or object reflectance may be different in the region of the second point relative to the region of the first point.

As discussed above, in some cases, certain points of a projected pattern may not be detectable at all due to factors such as noise (e.g., caused by ambient light and/or object reflectance), object position, point profile (e.g., shape and size), and the like. However, through calibration, the processing system may know at least approximately where points are expected to be detected. For instance, it may be known that between a first point and a second point, there should be a third point; however, the processing system may only detect the first point and the second point. In this case, the processing system may output an identifier for the third point, but without a calculated distance or set of three-dimensional coordinates for the third point. This indicates that the third point is present, but that information about the third point cannot be detected or determined with sufficient accuracy.

In further examples, the distance measurement characteristics may be output separately from the sets of three-dimensional coordinates, potentially in advance of the processing system calculating the sets of three-dimensional coordinates. For instance, information such as the conditions under which a point is detected (e.g., object reflectance, ambient lighting, etc.) may be detectable before the projected pattern is projected. The software parameter K of the distance sensor, which is discussed above and from which an accuracy of a set of calculated (x, y, z) coordinates can be determined, can also be known and outputted to an application prior to the sets of three-dimensional coordinates being calculated. Thus, this information may be output to an application separately from and prior to outputting the sets of three-dimensional coordinates. Then, when the sets of three-dimensional coordinates are output, the sets of three-dimensional coordinates may include identifiers of the corresponding points, without any additional information.

It should be noted that although not explicitly specified, some of the blocks, functions, or operations of the method 200 described above may include storing, displaying and/or outputting for a particular application. In other words, any data, records, fields, and/or intermediate results discussed in the method 200 can be stored, displayed, and/or outputted to another device depending on the particular application. Furthermore, blocks, functions, or operations in FIG. 2 that recite a determining operation, or involve a decision, do not imply that both branches of the determining operation are practiced. In other words, one of the branches of the determining operation may not be performed, depending on the results of the determining operation.

FIG. 6 depicts a high-level block diagram of an example electronic device 600 for measuring the distance from a distance sensor to an object. As such, the electronic device 600 may be implemented as a processor of an electronic device or system, such as a distance sensor.

As depicted in FIG. 6, the electronic device 600 comprises a hardware processor element 602, e.g., a central processing unit (CPU), a microprocessor, or a multi-core processor, a memory 604, e.g., random access memory (RAM) and/or read only memory (ROM), a module 605 for measuring the distance from a distance sensor to an object, and various input/output devices 606, e.g., storage devices, including but not limited to, a tape drive, a floppy drive, a hard disk drive or a compact disk drive, a receiver, a transmitter, a display, an output port, an input port, and a user input device, such as a keyboard, a keypad, a mouse, a microphone, a camera, a laser light source, an LED light source, and the like.

Although one processor element is shown, it should be noted that the electronic device 600 may employ a plurality of processor elements. Furthermore, although one electronic device 600 is shown in the figure, if the method(s) as discussed above is implemented in a distributed or parallel manner for a particular illustrative example, i.e., the blocks of the above method(s) or the entire method(s) are implemented across multiple or parallel electronic devices, then the electronic device 600 of this figure is intended to represent each of those multiple electronic devices.

It should be noted that the present disclosure can be implemented by machine readable instructions and/or in a combination of machine readable instructions and hardware, e.g., using application specific integrated circuits (ASIC), a programmable logic array (PLA), including a field-programmable gate array (FPGA), or a state machine deployed on a hardware device, a general purpose computer or any other hardware equivalents, e.g., computer readable instructions pertaining to the method(s) discussed above can be used to configure a hardware processor to perform the blocks, functions and/or operations of the above disclosed method(s).

In one example, instructions and data for the present module or process 605 for measuring the distance from a distance sensor to an object, e.g., machine readable instructions can be loaded into memory 604 and executed by hardware processor element 602 to implement the blocks, functions or operations as discussed above in connection with the method 200. Furthermore, when a hardware processor executes instructions to perform “operations”, this could include the hardware processor performing the operations directly and/or facilitating, directing, or cooperating with another hardware device or component, e.g., a co-processor and the like, to perform the operations.

The processor executing the machine readable instructions relating to the above described method(s) can be perceived as a programmed processor or a specialized processor. As such, the present module 605 measuring the distance from a distance sensor to an object of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or an electronic device such as a computer or a controller of a safety sensor system.

It will be appreciated that variants of the above-disclosed and other features and functions, or alternatives thereof, may be combined into many other different systems or applications. Various presently unforeseen or unanticipated alternatives, modifications, or variations therein may be subsequently made which are also intended to be encompassed by the following claims.

What is claimed is:

1. A method, comprising:
causing, by a processing system of a distance sensor including at least one processor, a light projecting system of the distance sensor to project a three-dimensional pattern onto an object, wherein the three-dimensional pattern comprises a plurality of points of light;
causing, by the processing system, a light receiving system of the distance sensor to capture an image of the three-dimensional pattern projected onto the object;
calculating, by the processing system, a first set of three-dimensional coordinates for a first point of the plurality of points of light, wherein the calculating is based on an appearance of the first point in the image and knowledge of a trajectory of the first point;
retrieving, by the processing system, a first distance measurement characteristic for the first point from a memory of the distance sensor, wherein the first distance measurement characteristic is measured during a calibration of the distance sensor;
appending, by the processing system, the first distance measurement characteristic to the first set of three-dimensional coordinates; and
outputting, by the processing system, a set of data including the first set of three-dimensional coordinates appended with the distance measurement characteristic.

2. The method of claim 1, further comprising:
repeating, by the processing system, the calculating, the determining, the appending, and the outputting for a second point of the plurality of points, independently of performing the calculating, the determining, the appending, and the outputting for the first point.

3. The method of claim 1, wherein the first distance measurement characteristic comprises a characteristic of the first point that affects an ability of the processing system to accurately detect the first point within the three-dimensional pattern and to identify the first point from among the plurality of points.

4. The method of claim 3, wherein the first distance measurement characteristic comprises a brightness of the first point.

5. The method of claim 3, wherein the first distance measurement characteristic comprises a physical profile of the first point.

6. The method of claim 3, wherein the first distance measurement characteristic comprises capture optics factor associated with the first point.

7. The method of claim 3, wherein the first distance measurement characteristic comprises a calibration specification associated with the first point.

8. The method of claim 7, wherein the calibration specification comprises a number of measured points forming a trajectory associated with the first point during a calibration of the distance sensor.

9. The method of claim 3, wherein the first distance measurement characteristic comprises an amount by which the first point deviates from a stored trajectory associated with the first point.

10. The method of claim 1, wherein the first distance measurement characteristic comprises at least one selected from a group of: an ambient temperature of the distance sensor and a temperature of a component of the distance sensor.

11. The method of claim 1, wherein the first distance measurement characteristic comprises at least one selected from a group of: a minimum value for a z coordinate of the first set of three-dimensional coordinates and a maximum value for the z coordinate of the first set of three-dimensional coordinates.

12. The method of claim 1, wherein the first distance measurement characteristic comprises a unique identifier of the first point.

13. The method of claim 1, wherein the first distance measurement characteristic comprises an indicator that describes a confidence in a detection and recognition of the first point.

14. The method of claim 13, wherein the confidence is based on conditions under which the detection and recognition occurred.

15. The method of claim 14, wherein the conditions include at least one selected from a group of: a reflectance of the object and a distance of the object.

16. The method of claim 1, wherein the first distance measurement characteristic comprises a repair history of the distance sensor.

17. The method of claim 1, further comprising:
outputting, for a second point of the plurality of points that the processing system fails to detect, an identifier without a distance measurement characteristic.

18. The method of claim 1, wherein the first distance measurement characteristic is re-measured and updated in the memory prior to the causing the light projecting system to project the three-dimensional pattern.

19. A non-transitory machine-readable storage medium encoded with instructions executable by a processing system of a distance sensor including at least one processor, wherein, when executed by the processing system, the instructions cause the processing system to perform operations, the operations comprising:
causing a light projecting system of the distance sensor to project a three-dimensional pattern onto an object, wherein the three-dimensional pattern comprises a plurality of points of light;
causing a light receiving system of the distance sensor to capture an image of the three-dimensional pattern projected onto the object;
calculating a first set of three-dimensional coordinates for a first point of the plurality of points of light, wherein the calculating is based on an appearance of the first point in the image and knowledge of a trajectory of the first point;
retrieving a first distance measurement characteristic for the first point from a memory of the distance sensor, wherein the first distance measurement characteristic is measured during a calibration of the distance sensor;
appending the first distance measurement characteristic to the first set of three-dimensional coordinates; and
outputting a set of data including the first set of three-dimensional coordinates appended with the distance measurement characteristic.

20. A distance sensor, comprising:
a processing system including at least one processor; and
a non-transitory machine-readable storage medium encoded with instructions executable by the processing system, wherein, when executed, the instructions cause the processing system to perform operations, the operations comprising:
causing a light projecting system of the distance sensor to project a three-dimensional pattern onto an object, wherein the three-dimensional pattern comprises a plurality of points of light;
causing a light receiving system of the distance sensor to capture an image of the three-dimensional pattern projected onto the object;
calculating a first set of three-dimensional coordinates for a first point of the plurality of points of light, wherein the calculating is based on an appearance of the first point in the image and knowledge of a trajectory of the first point;
retrieving a first distance measurement characteristic for the first point from a memory of the distance sensor, wherein the first distance measurement characteristic is measured during a calibration of the distance sensor;
appending the first distance measurement characteristic to the first set of three-dimensional coordinates; and
outputting a set of data including the first set of three-dimensional coordinates appended with the distance measurement characteristic.
